(19) United States
(12) Patent Application Publication
(10) Pub. No.: US 2017/0078609 A1
(43) Pub. Date: Mar. 16, 2017

(54) IMAGE PROCESSING METHOD AND APPARATUS BASED ON SCREEN SPLITING

(71) Applicant: QUOPIN CO., LTD., Seongnam-si (KR)

(72) Inventors: Hack Kyung KIM, Incheon (KR); Jung Sik MOON, Suwon-si (KR)

(73) Assignee: QUOPIN CO., LTD., Seongnam-si (KR)

(21) Appl. No.: 15/264,070

(22) Filed: Sep. 13, 2016

(30) Foreign Application Priority Data
Sep. 16, 2015 (KR) 10-2015-0130842
Sep. 8, 2016 (KR) 10-2016-0115656

(51) Int. Cl. H04N 5/38; H04N 19/124; G09G 5/39; H04N 19/179; H04N 5/445; H04N 19/44; H04N 19/14

(52) U.S. Cl. CPC H04N 5/38; H04N 19/44; H04N 19/124; H04N 19/14; H04N 19/179; H04N 5/44591; G09G 5/39; G09G 2360/12; G09G 2360/18

(57) ABSTRACT

Disclosed herein is an image processing apparatus based on the immediate transmission and reception of a split screen, including a transmission frame buffer configured to sequentially provide an image frame, an image encoder configured to control a compression method based on the complexity of the image frame, horizontally split the image frame, compress corresponding split image frames in accordance with the compression method, and provide the corresponding split and compressed image frames immediately, a reception frame buffer configured to buffer the corresponding split and compressed image frames, and an image decoder configured to decode the corresponding buffered and split and compressed image frames before buffering regarding the image frame is completed and display the corresponding decoded and split and compressed image frames immediately. Accordingly, an image frame can be split, compressed, and transmitted immediately without waiting for the entire image frame to be stored.

### BACKGROUND OF THE INVENTION

Field of the Invention

The present invention relates to an image processing technology based on the transmission and reception of a split screen and, more particularly, to an image processing apparatus and method based on the immediate transmission and reception of a split screen, which can transmit and output an image frame in real time.

Discussion of the Related Art

A video transmission stage, such as a broadcasting station, may encode video (e.g., the video may be compressed in accordance with the moving picture expert group (MPEG) standard) and transmit the encoded video to a video reception stage, such as home TV. The video reception stage may receive the video encoded by the video transmission stage and display the corresponding video. The video reception stage needs to decode the encoded video before displaying the corresponding video. In this case, the video transmitted between the video transmission stage and the video reception stage may have various types of resolution. In this case, resolution of the video may have an influence on an encoding time in the video transmission stage and a decoding time in the video reception stage. That is, the encoding time in the video transmission stage and the decoding time in the video reception stage are increased as resolution of the video increases.

Video is produced with high resolution with the development of a video photographing technology. A conventional video transmission/reception technology has a limit to a reduction of the time taken to encode and decode video produced with high resolution.

Korean Patent Application Publication No. 10-2001-0095106 discloses a video encoding apparatus and method for compressing and encoding a video signal, such as a high definition TV (HDTV) signal, a video camera for capturing a required image, generating a video signal, and encoding and recording the video signal, a video recording apparatus for recording the encoded video signal, and a video transmission apparatus for transmitting the encoded video signal.

### PRIOR ART DOCUMENT

### Patent Document

Korean Patent Application Publication No. 10-2001-0095106 (Nov. 3, 2001)

### SUMMARY OF THE INVENTION

An embodiment of the present invention is directed to the provision of an image processing apparatus and method based on the immediate transmission and reception of a split screen, which are capable of transmitting and outputting an image frame in real time.

An embodiment of the present invention is directed to the provision of an image processing apparatus and method based on the immediate transmission and reception of a split screen, which are capable of reducing time delay attributable to the compression and transmission of a high-resolution video screen by controlling a compression method according to the complexity of an image frame, horizontally splitting the image frame, and transmitting the split and compressed image frames immediately.

An embodiment of the present invention is directed to the provision of an image processing apparatus and method based on the immediate transmission and reception of a split screen, which are capable of securing the realtime of the compression, transmission, and output of a high-resolution video screen by displaying buffered split image frames immediately without waiting for all of image frames to be stored in a buffer.

In embodiments, an image processing apparatus based on the immediate transmission and reception of a split screen includes a transmission frame buffer configured to sequentially provide an image frame, an image encoder configured to control a compression method based on the complexity of the image frame, horizontally split the image frame, compress corresponding split image frames in accordance with the compression method, and provide the corresponding split and compressed image frames immediately, a reception frame buffer configured to buffer the corresponding split and compressed image frames, and an image decoder configured to decode the corresponding buffered and split and compressed image frames before buffering regarding the image frame is completed and display the corresponding decoded and split and compressed image frames immediately.

The image encoder may determine the complexity by determining a quasi-stationary property based on the size of a P-Frame assuming that the image frame is the P-Frame.

The image encoder may apply a quantization factor inversely proportional to a change of a difference between contiguous image frames as the compression method.

The image encoder may have the display environment of the image frame, displayed by the image decoder, fed back and control the horizontal split region of a next image frame.

The image encoder may receive the number of split image frames which belong to a plurality of split image frames included in the image frame and which are actually displayed from the image decoder.

The image encoder may control the horizontal split region of the next image frame so that the horizontal split region is inversely proportional to the number of actually displayed split image frames.

If split and compressed image frames associated with a next image frame are received before the display of split and compressed image frames associated with the image frame is completed, the image decoder may immediately display the split and compressed image frames associated with the next image frame before the reception of the split and compressed image frames associated with the image frame is completed.

If split and compressed image frames associated with a next image frame are received before the display of split and compressed image frames associated with the image frame is completed, the image decoder may enable the corresponding split and compressed image frames to be temporarily buffered in the image encoder and the buffered split and compressed image frames to be transmitted.

If the display of split and compressed image frames associated with the image frame is not completed within a specific time, the image decoder may temporarily buffer corresponding split and compressed image frames of an (n+1)-th image frame to a next k-th image frame (k is a natural number) in the reception frame buffer.

The image decoder may change the k based on a radio channel environment.

In embodiments, an image processing method based on the immediate transmission and reception of a split screen includes sequentially providing an image frame buffered in a transmission frame buffer, controlling a compression method based on the complexity of the image frame, horizontally splitting the image frame, compressing corresponding split image frames in accordance with the compression method, and providing the corresponding split and compressed image frames immediately through an image encoder, buffering the corresponding split and compressed image frames in a reception frame buffer, and decoding the corresponding buffered and split and compressed image frames before buffering regarding the image frame is completed and displaying the corresponding decoded and split and compressed image frames immediately through an image decoder.

### BRIEF DESCRIPTION OF THE DRAWINGS

FIG. 1 is a block diagram schematically showing an image processing apparatus based on the immediate transmission and reception of a split screen according to an embodiment of the present invention.

FIG. 2 is a block diagram illustrating the apparatus of a transmission stage of FIG. 1.

FIG. 3 is a block diagram illustrating the apparatus of a reception stage of FIG. 1.

FIG. 4 is a flowchart illustrating a process of encoding, by a transmission stage, an image frame using a specific compression method and transmitting the encoded image frame and buffering, by a reception stage, split and compressed image frames received from the transmission stage, decoding the buffered image frames, and outputting the decoded image frames to a display device.

FIG. 5 is a diagram illustrating an operation of a transmission frame buffer horizontally splitting an image frame and providing the split image frames to an image encoder.

FIG. 6 is a diagram illustrating an operation of an image buffer sequentially storing split image frames and providing them to the display device.

### DETAILED DESCRIPTION OF THE EMBODIMENTS

A description of the present invention is merely an embodiment for a structural and/or functional description. The scope of the present invention should not be construed as being limited to embodiments described in the context. That is, the embodiments may be modified in various forms, and the scope of the present invention should be construed as including equivalents which may realize the technical spirit. Furthermore, an object or effect proposed in the present invention does not mean that a specific embodiment should include all of objects or effects or should include a corresponding effect, and thus the scope of the present invention should not be understood to be restricted thereby.

The meaning of terms described in this application should be construed as follows.

The terms, such as the “first” and the “second”, are used to distinguish one element from the other element, and the scope of the present invention should not be restricted by the terms. For example, a first element may be named a second element. Likewise, a second element may be named a first element.

When it is said that one element is described as being “connected” to the other element, the one element may be directly connected to the other element, but it should be understood that a third element may be interposed between the two elements. In contrast, when it is described that one element is described as being “directly connected” to the other element, it should be understood that a third element is not interposed between the two elements. Meanwhile, the same principle applies to other expressions, such as “between ˜” and “just between ˜” or “adjacent to ˜” and “adjacent just to ˜”, which describe a relation between elements.

An expression of the singular number should be understood to include plural expressions, unless clearly expressed otherwise in the context. The terms, such as “include” or “have”, should be understood to indicate the existence of a set characteristic, number, step, operation, element, part, or a combination of them and not to exclude the existence of one or more other characteristics, numbers, steps, operations, elements, parts, or a combination of them or a possibility of the addition of them.

In each of steps, symbols (e.g., a, b, and c) are used for convenience of description, and the symbols do not describe order of the steps. The steps may be performed in order different from order described in the context unless specific order is clearly described in the context. That is, the steps may be performed according to described order, may be performed substantially at the same time, or may be performed in reverse order.

All the terms used herein, including technical or scientific terms, have the same meanings as those that are typically understood by those skilled in the art, unless otherwise defined. Terms, such as ones defined in common dictionaries, should be construed as having the same meanings as those in the context of related technology and should not be construed as having ideal or excessively formal meanings, unless clearly defined in the specification.

FIG. 1 is a block diagram schematically showing an image processing apparatus based on the immediate transmission and reception of a split screen according to an embodiment of the present invention.

Referring to FIG. 1, the image processing apparatus 110 based on the immediate transmission and reception of a split screen according to an embodiment of the present invention includes a transmission stage 112 and a reception stage 114. The transmission stage 112 and the reception stage 114 may be connected over a network.

The transmission stage 112 may receive input image frames, may perform encoding for splitting and compressing each of the image frames, and may transmit the split and compressed image frames to the reception stage 114. In this case, the input image 10 may be video. The term “split and compressed” refers to encoding a horizontally split portion or smaller portion of the entire image frame. That is, the transmission stage 112 may generate a plurality of split and compressed image frames by splitting each of the image frames into a plurality of split image frames and encoding each of the split image frames. The generated split and compressed image frames may be transmitted to the reception stage 114.

The reception stage 114 may receive the encoded split and compressed image frames from the transmission stage 112, may decode the split and compressed image frames, and may output the decoded split and compressed image frames to a display device 20. In this case, the display device 20 may be a screen display device, such as a handheld phone, a table PC, a monitor, or TV.

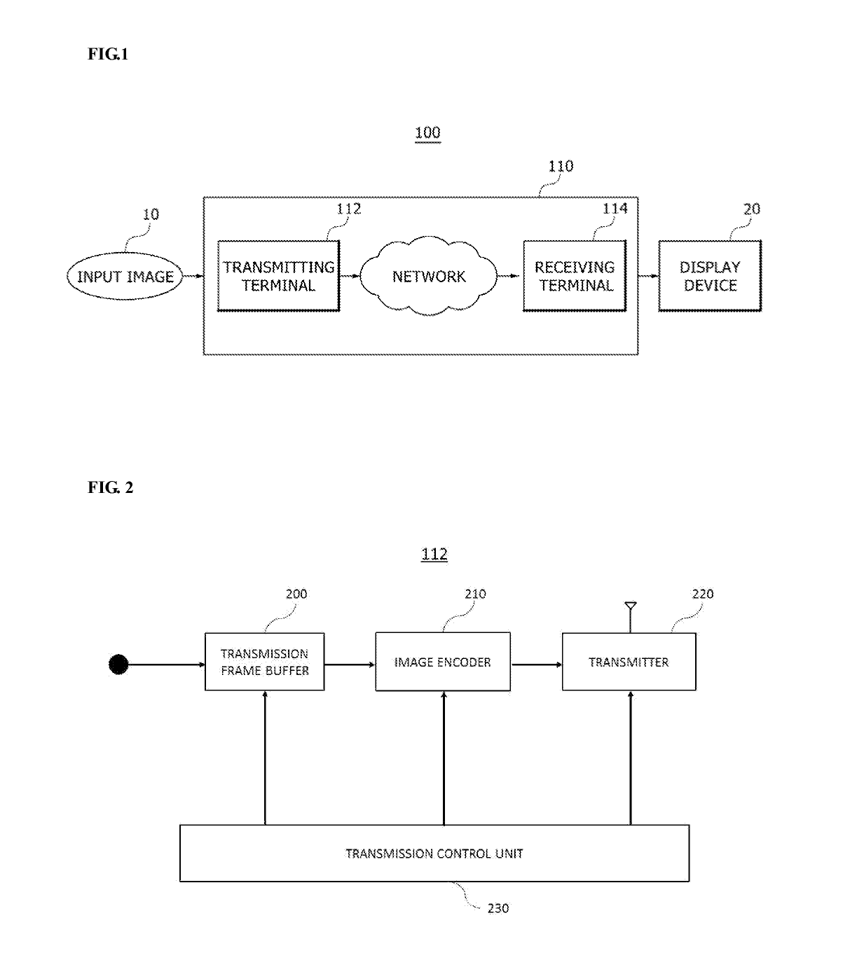

FIG. 2 is a block diagram illustrating the apparatus of the transmission stage of FIG. 1.

Referring to FIG. 2, the apparatus of the transmission stage 112 includes a transmission frame buffer 200, an image encoder 210, a transmitter 220, and a transmission control unit 230.

The transmission frame buffer 200 may horizontally split each of image frames that are sequentially received, and may sequentially provide the split image frames to the image encoder 210. For example, if five image frames are present, the transmission frame buffer 200 may sequentially store the first image frame to the fifth image frame in respective regions, and may horizontally split each of the image frames. The split image frames of each image frame may be immediately provided to the image encoder 210. The operation of the transmission frame buffer 200 is described in detail below with reference to FIG. 5.

In an embodiment, an image frame may be horizontally split by controlling a split region with consideration taken of the transmission environment of previously transmitted split and compressed image frames. For example, the transmission frame buffer 200 may equally or inequally split the image frame horizontally under the control of a transmission control unit 230.

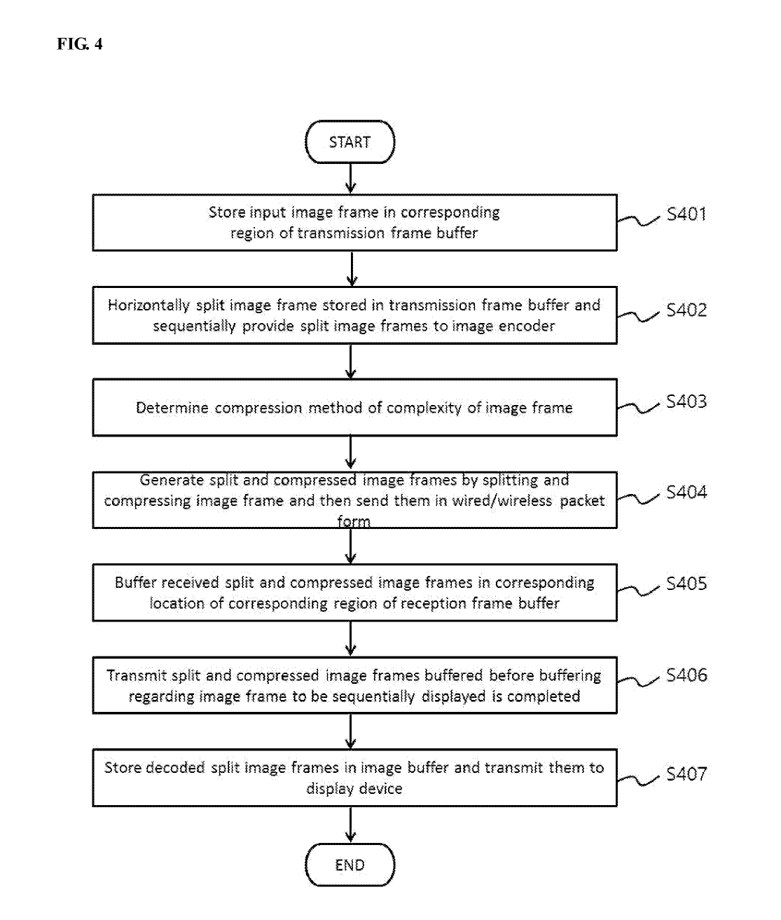

The image encoder 210 may control an image frame in accordance with a predetermined compression method or may determine the complexity of an image frame and control a compression method, may compress corresponding split image frames in accordance with the compression method, and may generate split and compressed image frames. The complexity and the compression method are described in detail later with reference to FIG. 4.

The image encoder 210 may determine the complexity of an n-th image frame according to a quasi-stationary property, and may compress an image frame in such a way as to control a ratio of an intra frame (I-Frame) used and a predicted frame (P-Frame) used. In an embodiment, the quasi-stationary property of the n-th image frame may be determined based on the size of a corresponding P-Frame, assuming that the n-th image frame is the P-Frame. The quasi-stationary property and a method for controlling the ratio of an I-Frame used and a P-Frame used are described in detail later with reference to FIG. 4.

The image encoder 210 may determine the complexity of an n-th image frame based on a difference between contiguous image frames, and may compress the image frame in such a way as to apply a quantization factor (Q-Factor) to the image frame. In an embodiment, the complexity of the n-th image frame may be determined based on a change of a difference between previous and current image frames. A quantization factor inversely proportional to the determined change of a difference may be selected. In another embodiment, the complexity of the n-th image frame may be determined based on a change of a difference between current and next image frames, and a quantization factor proportional to the determined change of a difference may be selected. A compression method according to the selection of the quantization factor is described in detail later with reference to FIG. 4. In another embodiment, the image encoder 210 may control a compression size so that it is proportional or inversely proportional to the compressed size of an I-Frame and a change of a difference between contiguous next image frames.

The transmitter 220 may transmit split and compressed image frames, that is, the split and compressed image frames generated by the image encoder 210 immediately, in the form of a wired/wireless packet. That is, the transmitter 220 may transmit the generated split and compressed image frames in a wired/wireless packet form without waiting for a single n-th image frame to be fully encoded. Furthermore, the image encoder 210 may continue to split and compress the remaining portions of the n-th image frame independently of the transmission of the split and compressed image frames.

The transmission control unit 230 may control the transmission frame buffer 200, the image encoder 210, and the transmitter 220 so that the process of horizontally splitting, by the transmission frame buffer 200, an image frame, determining, by the image encoder 210, the complexity of the image frame, controlling a compression method, and generating split and compressed image frames in accordance with the compression method, and transmitting, by the transmitter 220, the split and compressed image frames immediately in the form of a wired/wireless packet is repeated.

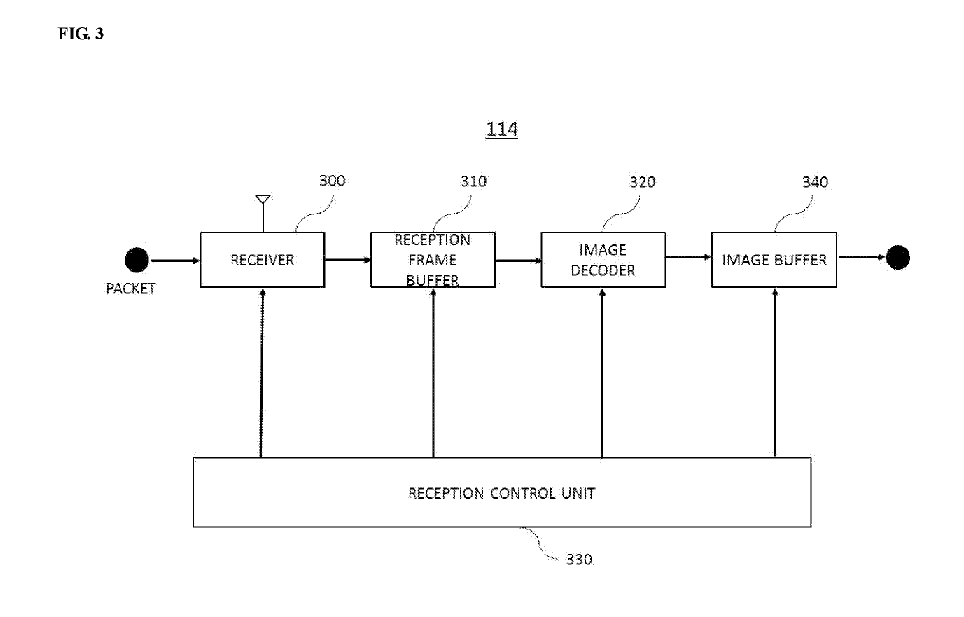

FIG. 3 is a block diagram illustrating the apparatus of the reception stage of FIG. 1.

Referring to FIG. 3, the apparatus of the reception stage 114 includes a receiver 300, a reception frame buffer 310, an image decoder 320, a reception control unit 330, and an image buffer 340.

The receiver 300 may receive split and compressed image frames from the transmission stage 112 and provide them to the reception frame buffer 310. The receiver 300 may provide the reception frame buffer 310 with the split and compressed image frames transmitted by the transmitter 220 in the form of a wired/wireless packet as soon as the image frames are received.

The reception frame buffer 310 may buffer the split and compressed image frames, provided by the receiver 300, in a corresponding location of a corresponding region of the reception frame buffer 310. The reception frame buffer 310 may transmit the split and compressed image frames to the image decoder 320 before buffering regarding a corresponding single image frame to be sequentially displayed is completed. That is, the reception frame buffer 310 may provide the image decoder 320 with the split and compressed image frames as soon as they are buffered without waiting for a corresponding single image frame to be fully buffered. In an embodiment, the number of split and compressed image frames to be transmitted to the image decoder 320 may be determined based on the transmission environment of previous image frames.

The image decoder 320 may sequentially receive split and compressed image frames buffered in a corresponding region of the reception frame buffer 310, may decode the buffered and split and compressed image frames, and may store the decoded split image frames in the image buffer 340. The image decoder 320 may decode the split and compressed image frames as soon as they are received, and may store them in the image buffer 340.

In an embodiment, if split and compressed image frames of a next image frame are received before the display of split and compressed image frames associated with an image frame is completed, the image decoder 320 may display the split and compressed image frames of the next image frame immediately before the reception of the split and compressed image frames associated with the image frame is completed. If split and compressed image frames associated with a next image frame are received before the display of split and compressed image frames associated with an image frame is completed, the image decoder 320 may enable the split and compressed image frames associated with the next image frame to be temporarily buffered in the image encoder 210 and to be transmitted. For example, if split and compressed image frames of an (n+1)-th image frame are received before the display of split and compressed image frames of an n-th image frame is completed, the image decoder 320 may enable some of the split and compressed image frames of the n-th image frame other than split and compressed image frames that have not yet been received to be displayed. The image decoder 320 may perform control so that the split and compressed image frames of the (n+1)-th image frame are temporarily buffered in the image encoder 210 and transmitted.

In an embodiment, if the display of split and compressed image frames associated with an image frame is not completed within a specific time, the image decoder 320 may enable split and compressed image frames of an (n+1)-th image frame to a next k-th image frame to be temporarily buffered in the reception frame buffer 310. In this case, k corresponds to a natural number, and the image decoder 320 may change k based on a radio channel environment.

In an embodiment, k may be controlled according to the following equation.

k(x)=log(x+α)+c (α is a positive number) [Equation]

In this case, x is a bit error rate (BER), and c corresponds to a constant. The image decoder 320 may increase k controlled so that split and compressed image frames are buffered in the reception frame buffer 310 as a radio channel environment becomes deteriorated. For example, if the display of split and compressed image frames of a fifth image frame is not completed within 10 seconds, the image decoder 320 may enable split and compressed image frames of a sixth image frame to a next seventh image frame to be temporarily buffered in the reception frame buffer 310 according to Equation above.

A reception control unit 330 may control the receiver 300, the reception frame buffer 310, the image decoder 320, and the image buffer 340 so that the process of receiving, by the receiver 300, split and compressed image frames from the transmitter 220 and providing the split and compressed image frames to the reception frame buffer 310, buffering, by the reception frame buffer 310, the split and compressed image frames and transmitting he buffered and split and compressed image frames to the image decoder 320, decoding, by the image decoder 320, the split and compressed image frames buffered in the reception frame buffer 310 and storing the decoded split and compressed image frames in the image buffer 340, and providing, by the image buffer 340, the buffered split image frames to the display device 20 is repeated.

In an embodiment, the reception control unit 330 may control the receiver 300, the reception frame buffer 310, the image decoder 320, and the image buffer 340 so that a process of receiving, by the receiver 300, split and compressed image frames from the transmitter 220 and providing the split and compressed image frames to the reception frame buffer 310 and buffering, by the reception frame buffer 310, the split and compressed image frames and transmitting the buffered and split and compressed image frames to the image decoder 320 is repeated, and when the first split and compressed image frame of a next contiguous image frame starts to be stored in the reception frame buffer 310 or the k-th split image frame of the next contiguous image frame starts to be stored in the image buffer 340, split and compressed image frame of the next contiguous image frame are sequentially displayed from the first decoded split image frame stored in the image buffer 340. That is, the reception control unit 330 may control the display device 20 so that it displays a specific number of partial image frames when the specific number of partial image frames starts to be stored in the image buffer 340 or displays a next contiguous image frame when the next contiguous image frame starts to be inputted to the reception frame buffer 310, without waiting for a corresponding single image frame to be fully decoded.

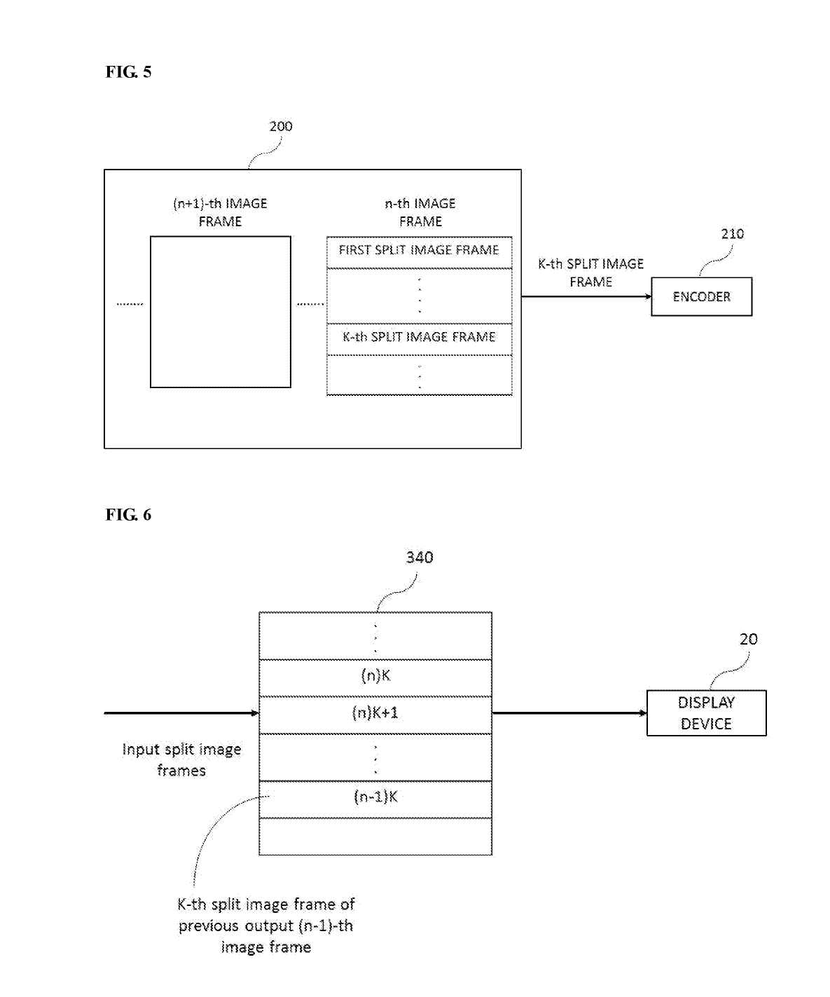

The image buffer 340 may store split image frames received from the image decoder 320, and may provide the stored split image frames to the display device 20 as soon as the split image frames are stored. The operation of the image buffer 340 is described in detail later with reference to FIG. 6.

FIG. 4 is a flowchart illustrating a process of encoding, by the transmission stage, an image frame using a specific compression method and transmitting the encoded image frame and buffering, by the reception stage, split and compressed image frames received from the transmission stage, decoding the buffered image frames, and outputting the decoded image frames to a display device.

Referring to FIG. 4, the transmission frame buffer 200 may store an input image frame in a corresponding location of a corresponding region in an image frame unit (S401). The transmission frame buffer 200 may horizontally split the stored image frame and sequentially provide the split image frames to the image encoder 210 (S402).

The image encoder 210 may first determine the complexity of the image frame received from the transmission frame buffer 200 and then determine a compression method based on the determined complexity (S403). The complexity of an n-th image frame may be determined using a method of determining the quasi-stationary property of the n-th image frame based on the size of a corresponding P-Frame assuming that the corresponding image frame is the P-Frame, a method of determining the complexity based on a change of a difference between previous and current image frames, or a method of determining the complexity based on a change of a difference between current and next image frames.

In this case, the quasi-stationary property is an expression of a physical quantity which has a very small change with respect to time. Image frames consists of a collection of an I-Frame and P-Frames. MPEG encoding is performed in such a way as to control the number of I-Frames and the number of P-Frames. The I-Frame is a key frame, and is the entire figure directly compressed from a source. That is, the I-Frame has good picture quality, but has a high capacity. The P-Frame is constructed based on information about a previous key frame (I-Frame) and has poorer picture quality than an I-Frame, but has a low capacity. That is, if the size of a P-Frame is small, it means that a change of an image frame is small and the image frame may be treated as being a screen close to a still screen. Accordingly, a change of picture quality and the amount of compressed data can be reduced by increasing a ratio of P-Frames used. The amount of compressed data can be controlled by controlling a ratio of P-Frames used with respect to an I-Frame as described above.

If the complexity of an n-th image frame is determined based on a change of a difference between previous and current image frames, the image encoder 210 may select a quantization factor inversely proportional to the determined change of a difference and determine a compression method. For example, if a change of a current image frame is greater than that of a previous image frame, a low quantization factor (Q-Factor) may be selected because the amount of data to be compressed needs to be increased. In this case, as the value of the quantization factor is reduced, the amount of compressed data is increased.

If the complexity of an n-th image frame is determined based on a change of a difference between current and next image frames, the image encoder 210 may select a quantization factor proportional to the determined change and determine a compression method. For example, if a change of a next image frame is greater than that of a current image frame, a high quantization factor (Q-Factor) may be selected because the amount of data to be compressed in the current image frame is relatively reduced.

In an embodiment, the complexity of an n-th image frame and a compression method may be determined using a method for controlling a compression size so that it is proportional or inversely proportional to the compressed size of an I-Frame and a change of a difference between contiguous next image frames.

The image encoder 210 may control the horizontal split region of an n-th image frame by incorporating the transmission environment of previously transmitted split and compressed image frames. Accordingly, the corresponding image frame may be horizontally split. The image encoder 210 may generate split and compressed image frames by compressing the split image frames in accordance with a compression method.

In an embodiment, the image encoder 210 may have the display environment of an image frame, displayed by the image decoder 320, fed back, and may control the horizontal split region of a next image frame. The image encoder 210 may control the horizontal split region of a next image frame so that the number of split image frames that belong to a plurality of the split image frames included in the image frame and that are actually displayed is received from the image decoder 320 and the horizontal split region is inversely proportional to the number of actually received split image frames. For example, if the entire image frame has been split and compressed into 10 image frames and 6 or less actually displayed split image frames of the 10 image frames are received from the image decoder 320, the image encoder 210 may control the horizontal split region of a next image frame so that the next image frame is split and compressed into 10 or more image frames.

The transmitter 220 may transmit the generated split and compressed image frames in a wired/wireless packet form (S404). The transmission control unit 230 may control the process so that it is repeated if an image frame stored in the transmission frame buffer 200 is not the last image frame.

The split and compressed image frames transmitted from the reception stage to the transmission stage may be buffered in a corresponding location of a corresponding region of the reception frame buffer 310 (S405). The reception frame buffer 310 transmits the split and compressed image frames buffered in the image decoder 320 before buffering regarding a corresponding single image frame to be sequentially displayed is completed (S406).

The image decoder 320 decodes the split and compressed image frames received from the reception frame buffer 310 and stores the decoded split image frames in the image buffer 340. The image buffer 340 stores the split image frames received from the decoder 320 and transmits them to the display device 20 (S407). If an image frame stored in the reception frame buffer 310 is not the last image frame, the reception control unit 330 controls the process so that it is repeated.

FIG. 5 is a diagram illustrating an operation of the transmission frame buffer 200 horizontally splitting an image frame and providing the split image frames to the image encoder.

Referring to FIG. 5, the transmission frame buffer 200 may sequentially store continuously received image frames one by one, and may horizontally split an n-th image frame. The transmission frame buffer 200 may provide the split image frames to the image encoder 210 immediately. That is, a first split image frame to a k-th split image frame may be sequentially transmitted to the image encoder 210. The transmission frame buffer 200 may start to split a next (n+1)-th image frame after the splitting of the n-th image frame is completed.

FIG. 6 is a diagram illustrating an operation of the image buffer 340 sequentially storing split image frames and providing them to the display device.

Referring to FIG. 6, the image buffer 340 may sequentially store decoded split image frames. Furthermore, the image buffer 340 may provide a specific number of split image frames to the display device 20 when the specific number of split image frames is stored in the image buffer 340 without waiting for the image decoder 320 to fully decode a corresponding single image frame. That is, when the k-th split image frame of a previous (n−1)-th image frame is stored, the image buffer 340 may provide split image frames of the (n−1)-th image frame to the display device 20 and sequentially store (n)k split image frames of an n-th image frame.

The disclosed technology may have the following effects. However, it is not meant that a specific embodiment should include all of the following effects or include only the following effects, and thus the scope of the disclosed technology should not be construed as being restricted by the description.

The image processing apparatus based on the immediate transmission and reception of a split screen according to an embodiment of the present invention can transmit and output an image frame in real time.

The image processing apparatus based on the immediate transmission and reception of a split screen according to an embodiment of the present invention can reduce time delay attributable to the compression and transmission of a high-resolution video screen by controlling a compression method according to the complexity of an image frame, horizontally splitting the image frame, and transmitting the split and compressed image frames immediately. Furthermore, the amount of transmission data can be controlled by controlling a compression method.

The image processing apparatus based on the immediate transmission and reception of a split screen according to an embodiment of the present invention can secure the realtime of the compression, transmission, and output of a high-resolution video screen by displaying buffered split image frames immediately without waiting for the entire image frame to be stored in a buffer.

Although some exemplary embodiments of the present invention have been described above, those skilled in the art will appreciate that the present invention can be modified and changed in various ways without departing from the spirit and scope of the present invention which are written in the claims below.

What is claimed is:

1. An image processing apparatus based on an immediate transmission and reception of a split screen, the image processing apparatus comprising:
a transmission frame buffer configured to sequentially provide an image frame;
an image encoder configured to control a compression method based on a complexity of the image frame, horizontally split the image frame, compress corresponding split image frames in accordance with the compression method, and provide the corresponding split and compressed image frames immediately;
a reception frame buffer configured to buffer the corresponding split and compressed image frames; and
an image decoder configured to decode the corresponding buffered and split and compressed image frames before buffering regarding the image frame is completed and display the corresponding decoded and split and compressed image frames immediately.

2. The image processing apparatus of claim 1, wherein the image encoder determines the complexity by determining a quasi-stationary property based on a size of a P-Frame assuming that the image frame is the P-Frame.

3. The image processing apparatus of claim 2, wherein the image encoder applies a quantization factor inversely proportional to a change of a difference between contiguous image frames as the compression method.

4. The image processing apparatus of claim 1, wherein the image encoder has a display environment of the image frame displayed by the image decoder fed back and controls a horizontal split region of a next image frame.

5. The image processing apparatus of claim 4, wherein the image encoder receives a number of split image frames which belong to a plurality of split image frames included in the image frame and which are actually displayed from the image decoder.

6. The image processing apparatus of claim 5, wherein the image encoder controls the horizontal split region of the next image frame so that the horizontal split region is inversely proportional to the number of actually displayed split image frames.

7. The image processing apparatus of claim 1, wherein if split and compressed image frames associated with a next image frame are received before a display of split and compressed image frames associated with the image frame is completed, the image decoder immediately displays the split and compressed image frames associated with the next image frame before a reception of the split and compressed image frames associated with the image frame is completed.

8. The image processing apparatus of claim 1, wherein if split and compressed image frames associated with a next image frame are received before a display of split and compressed image frames associated with the image frame is completed, the image decoder enables the corresponding split and compressed image frames to be temporarily buffered in the image encoder and the buffered split and compressed image frames to be transmitted.

9. The image processing apparatus of claim 1, wherein if a display of split and compressed image frames associated with the image frame is not completed within a specific time, the image decoder temporarily buffers corresponding split and compressed image frames of an (n+1)-th image frame to a next k-th image frame (k is a natural number) in the reception frame buffer.

10. The image processing apparatus of claim 1, wherein the image decoder changes the k based on a radio channel environment.

11. An image processing method based on an immediate transmission and reception of a split screen, the image processing method comprising:
sequentially providing an image frame buffered in a transmission frame buffer;
controlling a compression method based on a complexity of the image frame, horizontally splitting the image frame, compressing corresponding split image frames in accordance with the compression method, and providing the corresponding split and compressed image frames immediately through an image encoder;
buffering the corresponding split and compressed image frames in a reception frame buffer; and
decoding the corresponding buffered and split and compressed image frames before buffering regarding the image frame is completed and displaying the corresponding decoded and split and compressed image frames immediately through an image decoder.
